(19) United States
(12) Patent Application Publication
(10) Pub. No.: US 2022/0316603 A1
(43) Pub. Date: Oct. 6, 2022

(54) CUTAWAY PETAL FOR DILATING DISK VALVE

(71) Applicant: CLARKE INDUSTRIAL ENGINEERING INCORPORATED, North Kingstown, RI (US)

(72) Inventors: Kyle P. Daniels, North Kingstown, RI (US); Mark Laurito, North Kingstown, RI (US)

(21) Appl. No.: 17/706,953

(22) Filed: Mar. 29, 2022

Related U.S. Application Data
(60) Provisional application No. 63/170,112, filed on Apr. 2, 2021.

(51) Int. Cl. F16K 3/04; F16K 3/02; F16K 3/03; F16K 27/04

(52) U.S. Cl. CPC F16K 3/04; F16K 3/029; F16K 3/03; F16K 27/04

(57) ABSTRACT

An obturator element is disclosed with a petal shaped structure. The petal shaped structure can include a first edge portion along a first section of an outside circumference of the petal shaped structure and a second edge portion along a second section of the outside circumference of the petal shaped structure. The second edge portion can include an insert with a partial surface positioned toward a first side of the petal shaped structure corresponding to a source direction of intended fluid flow. The insert can include a full surface positioned toward a second side of the petal shaped structure. The second edge can include a second mating surface at least partially formed by the insert. The petal shaped structure can include a control connection portion and a hinged connection portion. The obturator element can pivot about the hinged connection portion by movement of the control connection portion.

### CROSS-REFERENCE TO RELATED APPLICATIONS

This application claims the benefit of, and priority to, U.S. Provisional Application No. 63/170,112, filed Apr. 2, 2021, and entitled “CUTAWAY PETAL FOR DILATING DISK VALVE,” and relates to U.S. Pat. No. 9,970,554, filed Dec. 28, 2016, which are each incorporated by reference herein in their entireties.

### TECHNICAL FIELD

The present systems and processes relate generally to the field of valve systems, and more particularly relates to the use of petals in the field of dilating disk valves for pressure regulation and the control of fluids in machines.

### BACKGROUND

In fluid control systems, valves are vital components for facilitating restricting and allowing fluid to flow through a particular passageway. Commonly, valves include a closing obturator to restrict fluid flow through an aperture. The closing obturator can include one or more component, such as a petal, that moves into the path of the fluid flow to block fluid movement through the aperture. In this way, the petals combined with mechanical components of a valve are used to control fluid movement through passageways. In a dilating disk valve, the petals are designed to a precise geometric shape, and created as one solid piece of metal with a sealing surface from another material. This geometric shape may create areas of high fluid velocity under certain process conditions. In particular, when corrosive or high temperature fluids pass over the petals during opening and closing, if the velocity of the fluid is high enough, the sealing surface of these petals may erode or melt away.

Therefore, a geometric solution is needed, incorporating a sophisticated understanding of fluid dynamics, for a system or method that creates an adequate seal while maintaining structural integrity in difficult environments.

### BRIEF SUMMARY OF THE DISCLOSURE

Briefly described, and according to one embodiment, aspects of the present disclosure generally relate to systems and methods for sealing a passageway in a fluid management system. In various embodiments, the disclosed system includes a dilating disk valve. The dilating disk valve can be a mechanically and/or electronically operated valve system used to reduce and/or completely stop flow of fluids in a piping system. The dilating disk valve can include obturator elements (referred to herein as “petals”). The dilating disk valve can include a valve body, a gear mechanism, and at least three or more petals.

In a three petal dilating disk valve system, the petals are attached to the valve body and the gear mechanism. By activating the gear mechanism, the petals can rotate about the location they are attached on the valve body. As the petals rotate about the location they are attached on the valve body, the petals meet at the center of the dilating disk valve. Each petal can include a tongue and a groove. As the petals make contact to create a seal, the tongue of each petal connects with the groove of each adjacent petal. For example, the tongue of the first petal connects with the groove of the second petal; the tongue of the second petal connects with the groove of the third petal; and the tongue of the third petal connects with the groove of the first petal. As the petals make full contact at the center, the petals block any fluid from flowing through the dilating disk valve.

The petal can include a seal insert and a body. The body can be constructed from a metallic material (e.g., metal). Example materials for the body can include, but are not limited to, carbon steel, stainless steel, various metal alloys, and titanium. The petal body material of the petal is selected to withstand high temperature fluids, highly acidic fluids, highly basic fluids, and/or any other extreme fluid condition. The body provides structural integrity to the petal. The insert can be placed into the body of the petal. The insert can be designed to accept the tongue of the body of any particular adjacent petal. The insert can be made of Polytetrafluoroethylene (PTFE) materials. Creating the insert from PTFE can increase the sealing capabilities of the petal.

According to a first aspect, an obturator element, comprising: A) a petal shape structure; B) a first edge portion along a first section of an outside circumference of the petal shaped structure, the first edge portion comprising a first mating surface; C) a second edge portion along a second section of the outside circumference of the petal shaped structure, the second edge portion comprising: 1) an insert comprising a partial surface positioned toward a first side of the petal shaped structure corresponding to a source direction of intended fluid flow and a full surface positioned toward a second side of the petal shaped structure, the second side opposite the first side; and 2) a second mating surface at least partially formed by the insert; D) a control connection portion comprising a first aperture; and E) a hinged connection portion comprising a second aperture, wherein the obturator element is configured to pivot about the second aperture of the hinged connection portion based on a movement of the control connection portion.

According to a further aspect, the obturator element of the first aspect or any other aspect, wherein the partial surface comprises a partial ledge and the full surface comprises a full ledge.

According to a further aspect, the obturator element of the first aspect or any other aspect, wherein the second mating surface comprises the partial ledge of the insert and a second partial ledge of the petal shape structure, wherein the combination of the partial ledge and the second partial ledge form a second full ledge.

According to a further aspect, the obturator element of the first aspect or any other aspect, wherein a first edge of a first side wall of the insert intersects a second edge of a central surface, and a third edge of the first side wall abuts the partial ledge.

According to a further aspect, the obturator element of the first aspect or any other aspect, wherein the first mating surface comprises a tongue and the second mating surface comprises a groove, and the second mating surface is configured to mate with the first mating surface of an adjacent obturator element by inserting the tongue of the first mating surface of the adjacent obturator element into the groove of the first mating surface.

According to a further aspect, the obturator element of the first aspect or any other aspect, wherein the insert comprises a channel, the channel comprising a central surface, a first side wall, and a second side wall, the central surface being substantially perpendicular to the first side wall and the second side wall, wherein first side wall abuts the partial surface and the second side wall abuts the full surface.

According to a further aspect, the obturator element of the first aspect or any other aspect, wherein the second section of the obturator element is configured to mate with an adjacent obturator element and the first edge portion of the obturator element is configured to mate with a second adjacent obturator element to prevent fluid flow through a dilating disk valve.

According to a further aspect, the obturator element of the first aspect or any other aspect, wherein the insert comprises a non-metallic material.

According to a second aspect, a dilating disk valve, comprising: A) a body comprising an aperture; B) a plurality of obturator elements configured to restrict fluid flow through the aperture of the body, wherein each of the plurality of obturator elements comprising: 1) a petal shape structure; 2) a first edge portion along a first section of an outside circumference of the petal shaped structure, the first edge portion comprising a first mating surface; 3) a second edge portion along a second section of the outside circumference of the petal shaped structure, the second edge portion comprising: I) an insert comprising a partial surface positioned toward a first side of the petal shaped structure corresponding to a source direction of intended fluid flow ad a full surface positioned toward a second side of the petal shaped structure, the second side opposite the first side; and II) a second mating surface at least partially formed by the insert, the second mating surface being configured to mate with the first mating surface of an adjacent obturator element; 4) a control connection portion configured to mechanically couple to body; and 5) a hinged connection portion configured to couple to the body, wherein the obturator element is configured to pivot about the hinged connection portion based on a force applied to the control connection portion.

According to a further aspect, the dilating disk valve of the second aspect or any other aspect, wherein a first material of the insert comprises a lower density than a second material of the petal shape structure.

According to a further aspect, the dilating disk valve of the second aspect or any other aspect, wherein the petal shape structure for each of the plurality of obturator elements comprises a second partial surface positioned on a same side as the partial surface of the insert.

According to a further aspect, the dilating disk valve of the second aspect or any other aspect, wherein the partial surface of the insert comprises a partial side wall.

According to a further aspect, the dilating disk valve of the second aspect or any other aspect, further comprising a gear mechanism configured to fit within a ring shaped channel of the body, wherein the control connection portion is further configured to couple to the gear mechanism and each of the plurality of obturator elements is further configured to pivot about the hinged connection portion based on a movement of gear mechanism within the ring shaped channel.

According to a further aspect, the dilating disk valve of the second aspect or any other aspect, wherein the plurality of obturator elements comprise a first obturator element, a second obturator element, and a third obturator element, wherein the first mating surface of the first obturator element is configured to mate with the second mating surface of the second obturator element, the first mating surface of the second obturator element is configured to mate with the second mating surface of the third obturator element, and the first mating surface of the third obturator element is configured to mate with the second mating surface of the first obturator element.

According to a further aspect, the dilating disk valve of the second aspect or any other aspect, wherein the first edge portion comprises a first contoured shape and the second edge portion comprises a second contoured shape inverse to the first contoured shape.

According to a third aspect, a method, comprising: A) rotating a gear mechanism about a ring shaped channel in a body, wherein the body comprises an aperture; B) moving, via the gear mechanism, a plurality of obturator elements about a respective hinged connection portion by moving a respective control connection portion coupled to the gear mechanism, wherein each of the plurality of obturator elements comprises the respective hinged connection portion and the respective control connection portion; C) coupling a respective first edge portion positioned along a first section of an outside circumference of each of the plurality of obturator elements with a respective second edge portion along a second section of the outside circumference of an adjacent one of the plurality of obturator elements, wherein the respective second edge portion comprises an insert with a partial surface positioned toward a first side and a full surface positioned toward a second side, the second side being opposite the first side; and D) sealing, based at least in part on the coupling the respective first edge portion for each of the plurality of obturator elements with the respective second edge portion of the adjacent one of the plurality of obturator elements, the aperture of the body to prevent fluid from flowing through the aperture.

According to a further aspect, the method of the third aspect or any other aspect, wherein the respective first edge portion comprises a tongue shaped portion and the respective second edge portion comprises a groove shaped portion for each of the plurality of obturator elements.

According to a further aspect, the method of the third aspect or any other aspect, further comprising affixing the insert into a groove channel of the respective second edge portion of each of the plurality of obturator elements.

According to a further aspect, the method of the third aspect or any other aspect, further comprising aligning a first partial ledge of the insert with a second partial ledge of the respective second edge portion for each of the plurality of obturator elements.

According to a further aspect, the method of the third aspect or any other aspect, further comprising injecting a non-metallic material into a mold to form the insert.

These and other aspects, features, and benefits of the claimed embodiments will become apparent from the following detailed written description of embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a perspective view of a petal, according to one embodiment of the present disclosure;

FIG. 2 illustrates a front view of the petal, according to one embodiment of the present disclosure;

FIG. 3 illustrates a right perspective view of the petal, according to one embodiment of the present disclosure;

FIG. 4 illustrates an enhanced right perspective view of the petal, according to one embodiment of the present disclosure;

FIG. 5 illustrates an isolated view of the insert, according to one embodiment of the present disclosure;

FIG. 6 illustrates a front isolated view of the insert, according to one embodiment of the present disclosure;

FIG. 7A illustrates a perspective view of an exemplary petal, according to one embodiment of the present disclosure;

FIG. 7B illustrates a perspective view of the petal, according to one embodiment of the present disclosure;

FIG. 7C illustrates a front view of an exemplary petal, according to one embodiment of the present disclosure;

FIG. 8 illustrates a perspective view of a dilating disk valve, according to one embodiment of the present disclosure;

FIG. 9 illustrates a second perspective view of a dilating disk valve, according to one embodiment of the present disclosure;

FIG. 10 illustrates a perspective view of a partially closed dilating disk valve, according to one embodiment of the present disclosure;

FIG. 11 illustrates an enhanced view of a partially closed dilating disk valve, according to one embodiment of the present disclosure;

FIG. 12 illustrates a perspective view of a closed dilating disk valve, according to one embodiment of the present disclosure;

FIG. 13 illustrates a partially transparent view of a closed dilating disk valve, according to one embodiment of the present disclosure;

FIG. 14 illustrates a flowchart of a process, according to one embodiment of the present disclosure; and

FIG. 15 illustrates a flowchart of a process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Aspects of the present disclosure generally relate to dilating disk valves with cutaway petals and processes thereof.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Aspects of the present disclosure generally relate to systems and methods for flow management of a substance through a particular passageway. In various embodiments, the disclosed system combines a metal portion and a sealing portion (e.g., Polytetrafluoroethylene (PTFE)) with a cutaway design for a valve petal used for flow management. In some embodiments, the valve petal can be referred to as an obturator. An obturator can be a device that manages the flow of a substance through a passageway or aperture. In particular embodiments, the metal and PTFE valve petals include a metallic body and a sealing insert (e.g., an insert made at least in part from PTFE or other sealing material).

The combination of the metallic body with the sealing insert can allow for greater sealing capabilities via the sealing insert while maintaining structural integrity via the metal body for extreme (e.g. high temperature, high acidity, and/or highly corrosive) fluid management. The sealing insert can be suseptible to enhanced wear (e.g., erosion, corrosion, melting, etc.). The cutaway shape of the sealing insert positions metal material in most areas most succeptible to wear during use. By using the sealing insert, the valve petals can form an effective seal due to the PTFE's enhanced elasticity. The sealing material have a portion facing the source of fluid omitted/replaced by metal from the metal body to avoid excess wear on the sealing material under the turbulant forces on the petals caused when the valve is closing. The sealing material can facilitate a more effective sealing surface at seams between various metal petals. The metal body can provide structural integrity and resistance to erosion when used with extreme fluid conditions. The metallic body can have a protruding edge. The size of the protruding edge can substantially match the size of the cutaway portion of the sealing insert. The larger the size of the protruding portion of the metallic body, the less the sealing material is exposed to the extreme conditions.

The sealing insert can be appended to or affixed into the metallic body to create a single petal component. In at least one embodiment, the sealing insert can append to the metallic body by any adequate appending technique. Some adequate appending techniques can include, but are not limited to, welding, gluing, and riveting. In one or more embodiments, the sealing insert is held into place inside the metallic body using one or more pins. In one embodiment, the one or more pins includes two pins. The pins can anchor the sealing insert to the metallic body to secure the two components together. In one embodiment, the pins can be welded in place to hold the sealing insert. In some embodiments, the sealing insert can be pressure fit into a channel. The pins can be used to secure the pressure fitted sealing insert into the channel. In one or more embodiments, the pinning technique is paired with an appending technique or one or more other securing techniques to create a firm hold between sealing insert and the metallic body.

The metallic body can include a tongue protrusion that can fit into a groove of an adjacent petal. The metallic body can include a hinge aperture. The metallic body can be coupled to a valve body at the hinge aperture and pivot about the hinge aperture. The metallic body can include a control aperture. The metallic body can be affixed to a control mechanism at the control aperture. The control mechanism can move the metallic body between a first position and a second position via the control aperture. In some embodiments, the first position can be an open position that freely allows fluid flow through a fluid aperture. In some embodiments, the second position can be a closed position that prevents fluid from flying through the fluid aperture. The metallic body can be connected to a gear mechanism at the control aperture, and the metallic body can connect to a hinge pin at the hinge aperture. The gear mechanism can rotate the valve petal about the hinge pin into an opened or closed state. In some embodiments, the tongue is inserted into a groove in the insert of an adjacent valve petal during a closing procedure. In some embodiments, the tongue presses up against the adjacent valve's sealing insert to create a seal. In an at least two petal system, the petals can perform the closing procedure to facilitate sealing the valve. In certain embodiments, sealing the valve will stop the flow of substances through the particular passageway.

The valve can include at least two petals. The valve can include a rotating mechanism (e.g., a gear mechanism) that operatively opens or closes the valve petals. In some embodiments, the valve includes three petals, where each petal forms one-third of the closed valve surface. In particular embodiments, the valve can connect to a passageway system to control the flow of a particular substance. For example, the valve is connected between two portions of a pipe to control the flow of fluid, such as, for example, the flow of liquid nitrogen in a factory.

### Exemplary Embodiments

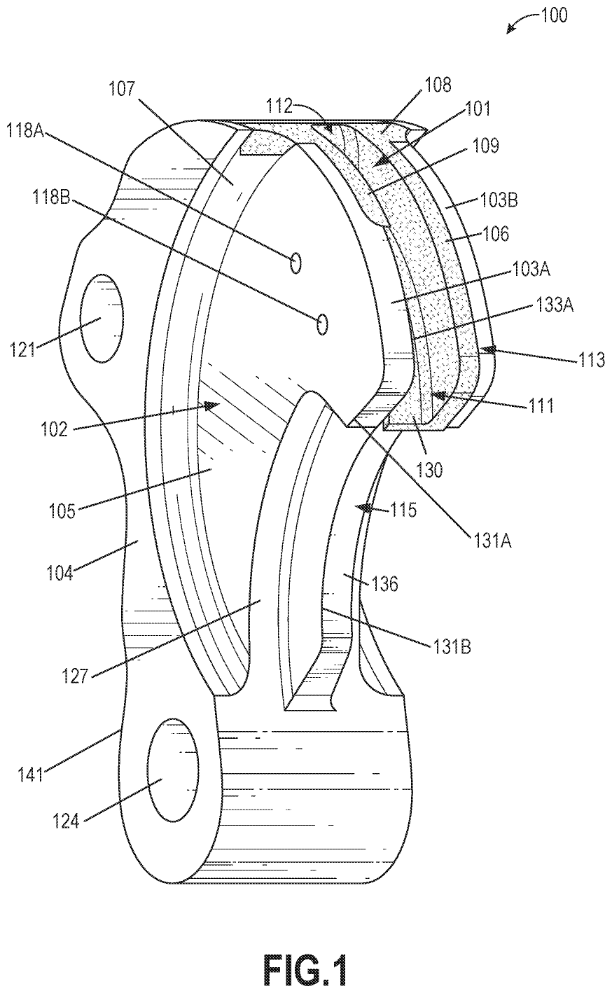

Referring now to the figures, for the purposes of example and explanation of the fundamental processes and components of the disclosed systems and processes, reference is made to FIG. 1, which illustrates an exemplary petal-shaped structure, referred to as a petal 100 according to one embodiment of the present disclosure. As will be understood and appreciated, the exemplary petal 100 shown in FIG. 1 represents merely one approach or embodiment of the present disclosure, and other aspects are used according to various embodiments of the present disclosure. In some embodiments the petal 100 can be referred to as an obturator element. The petal 100 can have a substantially petal shaped structure.

The petal 100 can include an insert 101 and a body 102. The insert 101 can include, but is not limited to, a full inner groove protrusion 106, a rear anchor 108, a cutaway inner groove protrusion 109, a groove 112, and a recessed surface 130. The body 102 can include, but is not limited to, one or more outer groove protrusions 103A and 103B, an upper surface 104, a lower surface 105, a curved surface 107, a groove channel 111, one or more apertures 118A and 118B, a tongue protrusion 115, a control aperture 121, a hinge aperture 124, and a tongue recessed portion 127. The recessed surface 130 can occupy a lowest, bottom, or recessed portion of the groove 112. The recessed surface 130 can be referred to as a central surface. The cutaway inner groove protrusion 109 can be referred to as a first side wall and/or a partial side wall. The full inner groove protrusion 106 can be referred to as a second side wall.

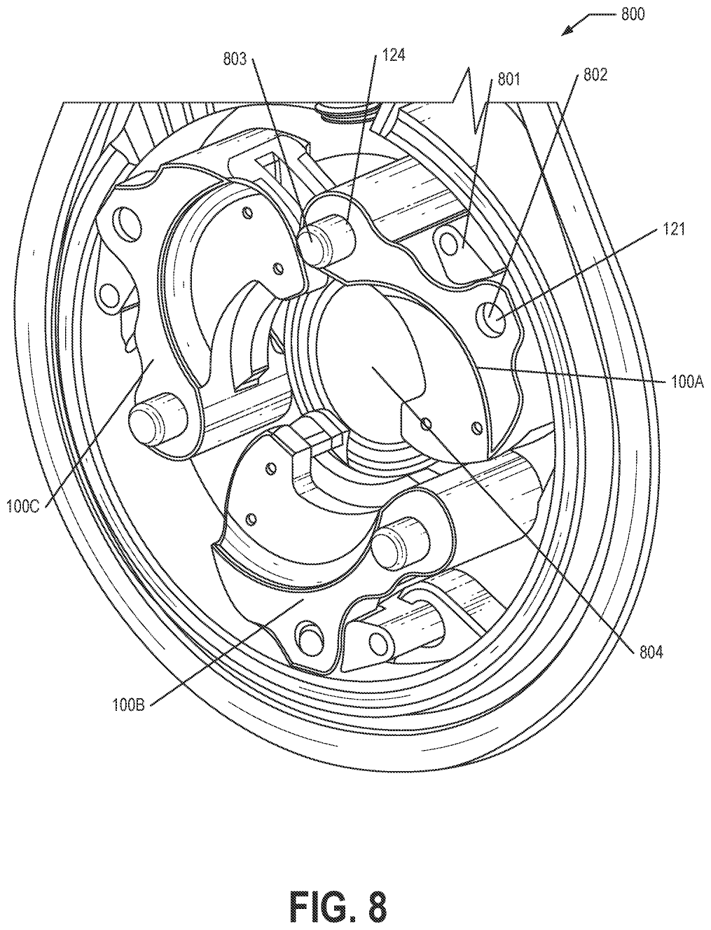

In some embodiments, a dilating disk valve 800 (see FIG. 8) can include two or more petals 100. In at least one embodiment, the dilating disk valve 800 can include three petals 100. A general shape of the petal 100 can be based on the number of petals 100 being used in the dilating disk valve 800. When in a closed position, the tongue protrusion 115 of a first petal 100 can fit within the groove 112 of a second petal 100. The tongue protrusion 115 can be shaped to have a first contour. The groove 112 can be shaped to have a second contour, which is inverse to the first contour of the tongue protrusion 115. In particular embodiments, the tongue protrusion 115 can be referred to as the first edge portion. In some embodiments, the groove 112 can be referred to as a second mating surface. The groove 112 can include the insert 101 and a portion of the body 102. For example, the groove 112 can include the cutaway inner groove protrusion 109 and the outer groove protrusion 103A (also referred to as a partial ledge). Continuing this example, combining the cutaway inner groove protrusion 109 and a second partial surface of the outer groove protrusion 103A can form a second full ledge of the groove 112. The first petal 100 can be adjacent to the second petal 100. In at least one embodiment when in the closed position, the tongue protrusion 115 of the second petal 100 can fit within the groove 112 of a third petal 100, and the tongue protrusion 115 of the third petal 100 can fit within the groove 112 of the first petal 100.

The dilating disk valve 800 can be configured to allow fluid to flow when in an open position. The dilating disk valve 800 can be configured to restrict fluid from flowing when in a closed positon. In some embodiments, the dilating disk valve 800 can be intended to allow fluid to flow in only one direction. As an example, the dilating disk valve 800 may include petals 100 with the cutaway inner groove protrusion 109 positioned on a first side of the dilating disk valve 800. The fluid can flow in the direction of the cutaway inner groove protrusion 109 on the first side of the dilating disc valve 800 towards the full inner groove protrusions 106 of the petals 100 positioned on a second side of the dilating disk valve 800.

The insert 101 of the petal 100 can be made from a sealing material. The sealing material of the insert 101 can be semi-ridged and/or substantially less ridged than a metallic material of the body 102. In one example, the sealing material includes Polytetrafluoroethylene (PTFE). In particular embodiment, the sealing material can be made from layers of metal and graphite. The layers of metal and graphite can include a graphite and steel layered laminate. In various embodiment, the insert 101 is made of the sealing material to increase the sealing factor of the petals 100 when the dilating disk valve 800 is in the closed position. For example, the groove 112 of the second petal 100 can receive the tongue protrusion 115 of the first petal 100. Continuing this example, the tongue protrusion 115 of the first petal 100 and the groove 112 of the second petal 100 can form a greater seal when the ridged material of the tongue protrusion 115 makes contact and presses into the semi-ridged material of the groove 112 of the second petal 100. The insert 101 can be manufactures using compression molding, injection molding, rotational molding, extrusion molding, blow molding, and/or any other suitable manufacturing technique. The sealing material of the insert 101 can be a lower density than the metallic material of the body 102.

The body 102 of the petal 100 can be made from a metallic material. In certain embodiments, the metallic material of the body 102 can include, but is not limited to, carbon steel, stainless steel, alloy steels, titanium, a composite material, and/or any other ridged material. The body 102 can be manufactured using injection molding, computer numerical control (CNC) machining, milling, blow molding, and/or any other adequate manufacturing technique. The material of the body 102 can be ridged to increase the structural integrity of the dilating disk valve 800 when in a closed position. The ridged material used for the body 102 can increase the structural integrity of the dilating disk valve 800 when transitioning from the opened to closed position. The metallic material of the body 102 can be substantially more ridged than the sealing material of the insert 101.

The dilating disk valve 800 can rotate the petals 100 about the hinge aperture 124 by applying a force on the control aperture 121. The control aperture 121 can be referred to as a control connection portion and/or a first aperture. The hinge aperture 124 can be referred to as a hinged connection portion and/or a second aperture. The petals 100 can move between a first position corresponding to the dilating disk valve 800 being open (e.g., fluid can pass through the dilating disk valve 800) to a second position corresponding to the dilating disk valve 800 being closed (e.g., fluid is prevented from passing through the dilating disk valve 800). For example, the petal can move from the first position to the second position by pivoting about the hinge aperture 124 based on a movement of the control aperture 121. In some embodiments the petals 100 of the dilating disk valve 800 can move from the closed position to the opened position to facilitate fluid flow. During a transition from the first position to the second position, the petals 100 are forced into the pathway of fluid flowing through the dilating disk valve 800. Once fully closed, the dilating disk valve 800 can substantially reduce the volume of fluid passing through the dilating disk valve 800. For example, in a closed state the dilating disk valve 800 can allow 0 milliliters (ml) of fluid to flow through the dilating disk valve 800 over a minute. For example, in a closed state the dilating disk valve 800 can allow 46 ml of fluid to flow through the dilating disk valve 800 over a minute.

The body 102 can include the outer groove protrusion 103A (also referred to as a partial surface and/or partial ledge). The outer groove protrusion 103A can be positioned toward a first side of the petal 100. In some embodiments, the outer groove protrusion 103A can be in a source direction of intended fluid flow. For example, the fluid first makes contact with the body 102 at the outer groove protrusion 103A. The body 102 can include the outer groove protrusion 103B (also referred to as a full surface and/or full ledge). The outer groove protrusion 103B can be positioned toward a second side of the petal 100. In particular embodiments, the second side is opposite the first side.

The fluid flow can create a greater force than under normal conditions on outer edges 131A-B and an inner edge 133A. The outer edge 131A can extend from the top of the curved surface 107 (e.g., nearest to the rear anchor 108) to the bottom of the curved surface 107 (e.g. nearest to the tongue protrusion 115). The outer edge 131B can extend along the sides of the tongue protrusion 115. The inner edge 133A can extend the length of the outer groove protrusion 103A not in contact with the cutaway inner groove protrusion 109. The outer edges 131A-B can be substantially similar on both sides of the petal 100. In particular embodiments, the outer edges 131A-B and the inner edge 133A of the petals 100 facing the direction of fluid flow into the dilating disk valve 800 can experience heightened forces from the restricted fluid flow. Restricted fluid flow can occur when the dilating disk valve 800 is transitioning from the open position to the closed position or from the closed position to the opened position. Turbulence created by the fluid flowing over the outer edges 131A-B and the inner edge 133A of the petals 100 can produce heightened forces exerted on the outer edges 131A-B and the inner edge 133A of the petals 100.

The sealing material of the insert 101 may be less resistant than the metal material of the body 102 to the heightened forces experienced while closing or opening the dilating disk valve 800. For example, the sealing material may be less resistant than the metallic material especially when the fluid corresponds to a corrosive material such as high temperature fluids, acidic fluids, or basic fluids, etc. The lower resistance of the sealing material of the insert 101 compared to the metallic material of the body 102 can be attributed to its lower rigidity. In some embodiments, the sealing material of the insert 101 may wear away, deform, or deteriorate over time if used along the inner edge 133A of the groove protrusion 103A. For example, the sealing material of the insert 101 may wear away from fluid vapors if positioned on the inner edge 133A. In some embodiments, the sealing material of the insert 101 has a rigidity and resistance to deformation less than the rigidity of the metallic material of the body 102.

The tongue protrusion 115 can be referred to as a first mating surface. The tongue protrusion 115 can be defined by a first edge portion (e.g., an outer edge 131B) along a first section of an outside circumference of the petal 100. The first section of the outside circumference can be referred to as the tongue recessed portion 127. In some embodiments, the outer groove protrusions 103A-B can combine to demarcate a second edge portion. The groove protrusions 103A-B can outline the groove channel 111. The groove protrusions 103A-B can extend along a second section of the outside circumference of the petal 100. For example, the second section of the outside circumference can include a top surface 113. The top surface 113 can extend continuously including the outer groove protrusions 103A-B, the insert 101 and portions of the body 102.

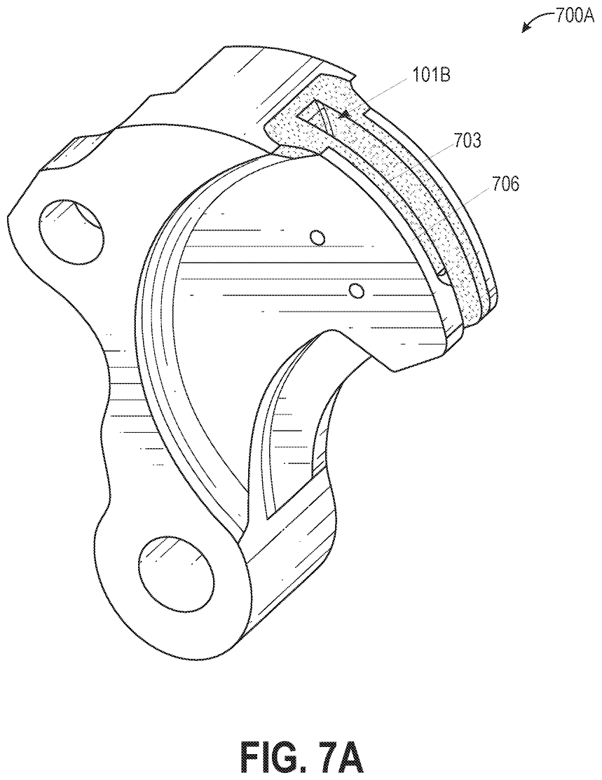

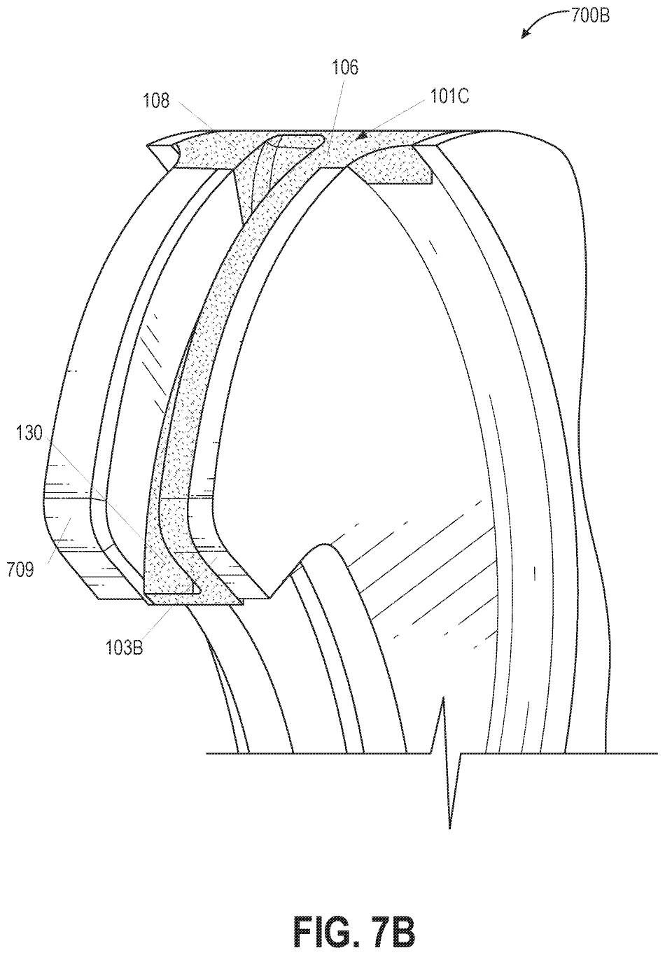

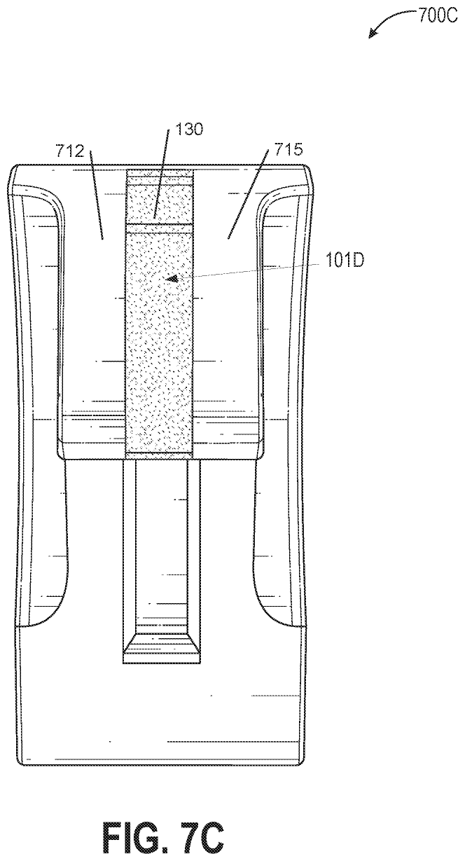

The cutaway inner groove protrusion 109 as compared to the full inner groove protrusion 106 can omit an extended portion of the sealing material. The omitted portion of the cutaway inner groove protrusion 109 can be referred to as a cutaway portion. The cutaway portion can be replaced with the metallic material of the body 102. For example, the out groove protrusion 103A can occupy the space vacated by the cutaway portion of the cutaway inner groove protrusion 109. In some embodiments, the cutaway portion can vary in size. For example, the size of the cutaway portion can be increased to increase the size of the outer groove protrusion 103A. In another example, the size of the cutaway portion can be decreased to decrease the size of the outer groove protrusion 103A. In some embodiments, the outer groove protrusion 103A can completely replace the cutaway inner groove protrusion 109 (see FIG. 7C). In various embodiments, the cutaway inner groove protrusion 109 can completely replace the outer groove protrusions 103A (see FIG. 7D). In some embodiments, the metallic material can replace (e.g., in part or in whole) the sealing material on one or both of the inner edges as indicated by the full inner groove protrusion 106, the cutaway inner groove protrusion 109, and the inner edge 133A. In one embodiment, the sealing material may be limited to the recessed surface 130 and anything below (e.g., the portion that interfaces with or is in contact with apertures 118A, 118B among others). For example, the full inner groove protrusion 106 and the inner groove protrusion 109 are removed and replaced with the metallic material of the body 102.

As used herein, the term “replaced” can be used to mean replaced in a design rather than to indicate that something is physically replaced. For example, the cutaway inner groove protrusion 109 as compared to the full inner groove protrusions 106 can be said to have a portion “replaced” with a metallic material from the body 102 in the design of the petal 100.

The inner edge 133A can correspond to the portion of the petal 100 that experiences the wear during closing over time. The edge of the fluid source side of the petal 100 including the inner edge 133A can experience greater wear during closing than other portions of the petal 100. The metallic material can be selected to withstand the heightened forces experienced during closing without wearing away. By replacing the sealing material in the design of the petal 100 with the metallic material at the cutaway portion, the longevity of the valve can be greatly increased. In some embodiments, the wear on the edge of the petal 100 can be mitigated. For example, using a highly ridged material for the metallic material of the body 102 can prolong the lifespan of the petal 100. Using the cutaway inner groove protrusion 109 rather than a full inner groove protrusions on the fluid source direction side of the petal 100 can increase the longevity of a dilating disk valve 800 by mitigating wear on the petals 100. For example, the dilating disk valve 800 can maintain an adequate seal for a greater period of time by delaying or preventing the sealing material from wearing away. Maintaining an adequate seal can include, but is not limited to, only allowing up to 46 ml of fluid flow through the dilating disk valve 800 in a closed position.

The body 102 can include the upper surface 104, the lower surface 105, and the curved surface 107. In some embodiments, the curved surface 107 divides the upper surface 104 from the lower surface 105. The curved surface 107 can transition the upper surface 104 to the lower surface 105. The curved surface 107 can help facilitate redirecting fluid pushing against the petal 100 in the dilating disk valve 800. For example, as the dilating disk valve 800 transitions from the opened position to the closed position, the curved surface 107 can help redirect fluid as the fluid flows against the closing petals 100.

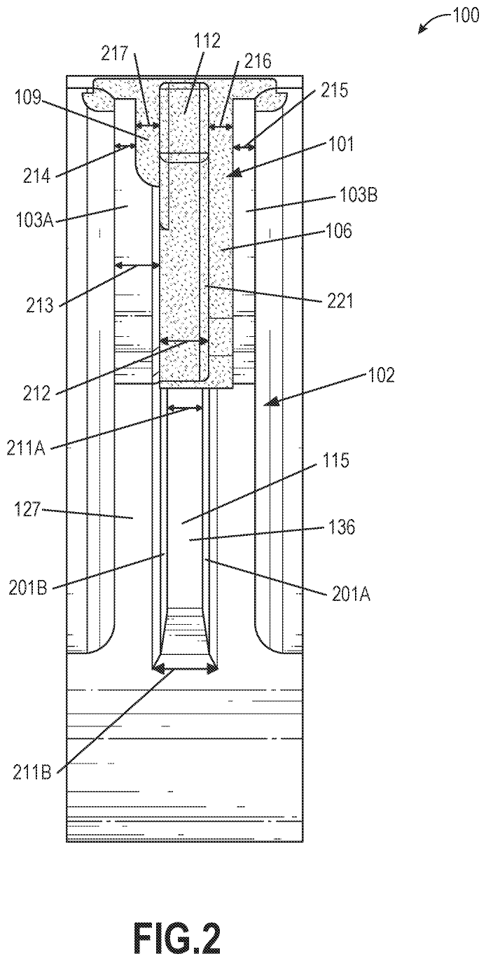

The insert 101 can provide a sealing surface when the tongue protrusion 115 of the first petal 100 is pressed against the groove 112 of the second adjacent petal 100. The recessed surface 130 can seal against a face 136 of the tongue protrusion 115. In some embodiments, a first side 201B and a second side 201A (see FIG. 2) of the tongue protrusion 115 can seal against the cutaway inner groove protrusion 109 and the full inner groove protrusion 106, respectively. In some embodiments, the use of the second material in the cutaway portion does not prevent the seal between two petals 100. For example, the recessed surface 130 and the face 136 can compress together to form a seal between two petals 100.

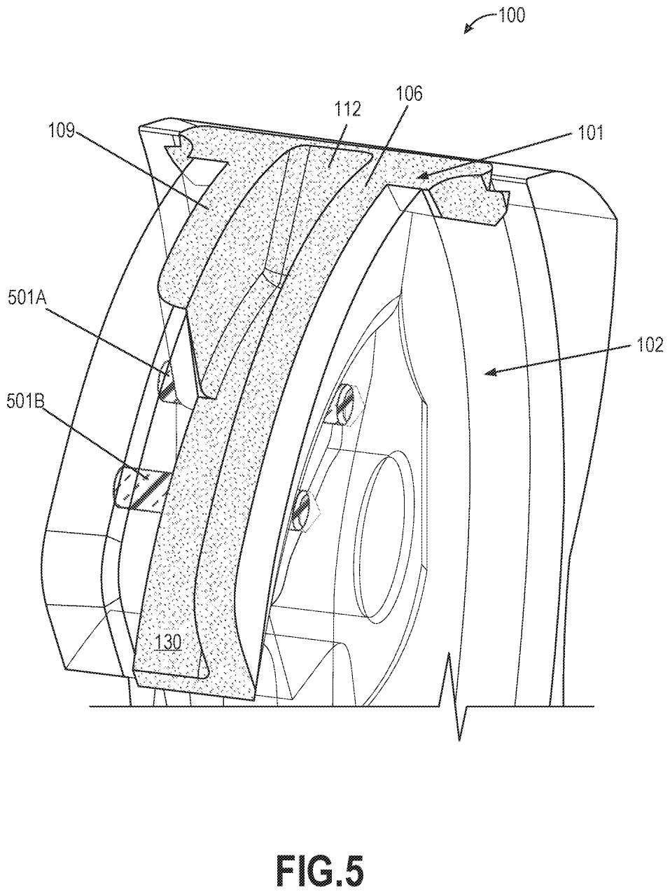

In some embodiments, the insert 101 can be friction fit into the groove channel 111 formed in the body 102. In particular embodiments, the insert 101 can be affixed to the body 102 via pins 501A-B (see FIG. 5). The insert 101 can be affixed to the body 102 using gluing, welding, any other appropriate appending technique, or a combination thereof. The pins 501A-B can be positioned in the apertures 118A-B. The pins 501A-B can pass through both the insert 101 and the body 102. The pins 501A-B can be fixed to the insert 101 and the body 102 by using welding, gluing, friction fitting, any other appending technique, or a combination thereof. The pins 501A and 501B can prevent the insert 101 from lifting out of the body 102 during use. The insert 101 can use the rear anchor 108 to further affix the insert 101 into the body 102. In particular embodiments, the insert 101 can include the rear anchor 108 to provide better stability and/or structural integrity when two petals 100 are compressed together.

In at least one embodiment, the cutaway inner groove protrusion 109 can cover a portion of the distance along from the recessed surface 130 outward toward the inner edge 133A. As an example, the entire inner edge 133A can correspond to the second material, while a portion of the way toward the recessed surface 130, the petal 100 can transition to the sealing material. The sealing material can occupy a portion of the sidewall of the groove 112 from an intersection with the recessed surface 130 up partway (e.g., 25% of the way, 50% of the way, 75% of the way, etc.) toward the inner edge 133A.

Referring now to FIG. 2, illustrated is a front view of the petal 100, according to one embodiment of the present disclosure. The petal 100 can have a substantially symmetrical composition. In some embodiments, the tongue protrusion 115 can include a first side 201B and a second side 201A. The first side 201B and second side 201A can be angled relative to the tongue recessed portion 127. For example, the first side 201B and a second side 201A are angled to reduce the width of the tongue protrusion 115 from the tongue recessed portion 127 to the face 136.

The petal 100 can include a tongue width 211A and an insert width 212. In various embodiments, the tongue width 211A is equal to or smaller than the insert width 212. By angling the first side 201B and the second side 201A, the tongue width 211A reduces relative to a tongue width 211B at the base of the tongue protrusion 115. By reducing the tongue width 211A relative to the insert width 212 and the tongue width 211B, the tongue protrusion 115 of the first petal 100 can fit into the groove 112 of the second petal 100 during a closing procedure. In an alternative example, if the tongue width 211A is larger than the insert width 212, the tongue protrusion 115 of a first alternative petal cannot fit into the groove 112 of a second alternative petal. In some embodiments, increasing the tongue width 211B relative to the tongue width 211A allows the tongue protrusion 115 to connect with the cutaway inner groove protrusion 109, the full inner groove protrusion 106, and the outer groove protrusion 103A.

The body 102 can include an outer groove width 213 and a cutaway width 214. Depending on the size of the insert 101, the cutaway width 214 can increase or decrease. In some embodiments, the outer groove width 213 and the cutaway width 214 are substantially similar. For example, if the cutaway inner groove protrusion 109 extends the entire length of the insert 101, the outer groove width 213 and the cutaway width 214 can be substantially equal. The body 102 can include a full groove width 215. The full groove width can measure the width of the outer groove protrusion 103B. In various embodiments, the full groove width 215 and the outer groove width 213 can be substantially similar. In some embodiments, the full groove width 215 and the cutaway width 214 can be substantially similar.

The insert 101 can include an insert first width 217 and an insert second width 216. In some embodiments, the insert first width 217 and the insert second width 216 are substantially similar. The insert first width 217 can measure the width of the cutaway inner groove protrusion 109. The insert second width 216 can measure the width of the outer groove protrusion 106.

The insert 101 can include a beveled edge 221. The beveled edge 221 can facilitate a transition between the cutaway inner groove protrusion 109, the full inner groove protrusion 106, and the recessed surface 130. For example, a first beveled edge 221 of the full inner groove protrusion 109 intersects a second beveled edge 221 of the recessed surface 130. Continuing this example, a third beveled edge 221 on the opposite side of the recessed surface 130 can abut the cutaway inner groove protrusion 106. The beveled edge 221 can increase the seal between the first petal 100 and the second petal 100. For example, the tongue protrusion 115 of the first petal 100 can press against the beveled edge 221 and the recessed surface 130 of the second petal 100 to create a greater seal. In some embodiments, the beveled edges 221 extend throughout the groove 112 and the insert 101. For example, beveled edges 221 can connect the recessed surface 130 to the full inner groove protrusion 106.

The groove 112 of the insert 101 can be referred to as a channel. The groove 112 can include the recessed surface 130, the cutaway inner groove protrusion 109, and the full inner groove protrusion 106. The recessed surface 130 can be substantially perpendicular to the cutaway inner groove protrusion 109 and the full inner groove protrusion 106. The cutaway inner groove protrusion 109 can abut the outer groove protrusion 103A and the full inner groove protrusion 106 can abut the outer groove protrusion 103B.

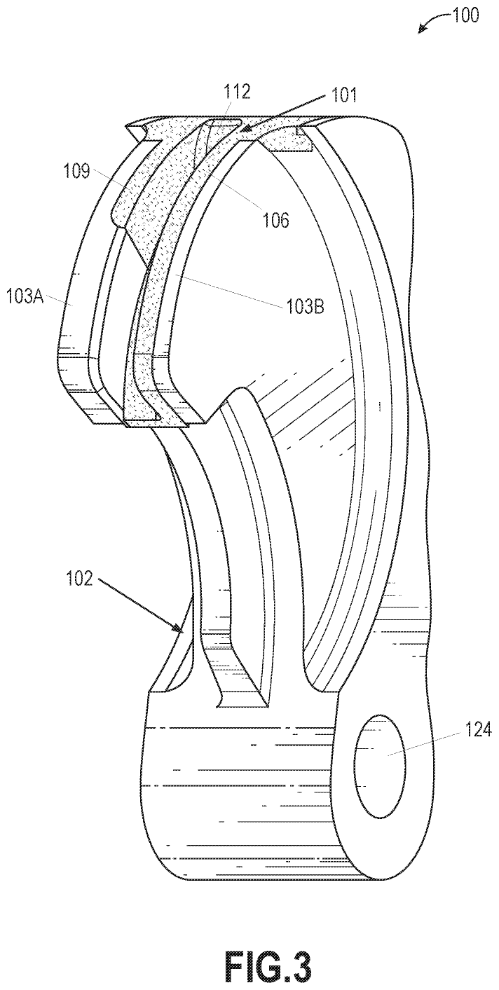

Referring now to FIG. 3, illustrated is a right perspective view of the petal 100, according to one embodiment of the present disclosure. In some embodiments, the petal 100 has a cutaway inner groove protrusion 109 can replace approximately 50% of the second material of the outer groove protrusion 103A. The cutaway groove protrusion 109 can replace from 0% to 100% of the outer groove protrusion 103A. In various embodiments, the full inner groove protrusion 106 can be substantially similar in length to the outer groove protrusion 103B. The full inner groove protrusion 106 can be substantially similar to the cutaway inner groove protrusion 109. For example, a petal can have two sides with cutaway portions. The aperture 124 can pass from the first side to the second side of the petal 100. In some embodiments, the hinge aperture 124 can accept a hinge pin 803 (see FIG. 8). The petal 100 can rotate around the hinge pin 803 when transitioning form the opened to closed position or from the closed to the opened position. In some embodiments, the pins 501A-B do not extend through the opposing side of the body 102. For example, the pins 501A-B can be inserted on a first side of the body 102, extend through the insert 101, and through a partial amount of a second side of the body 102.

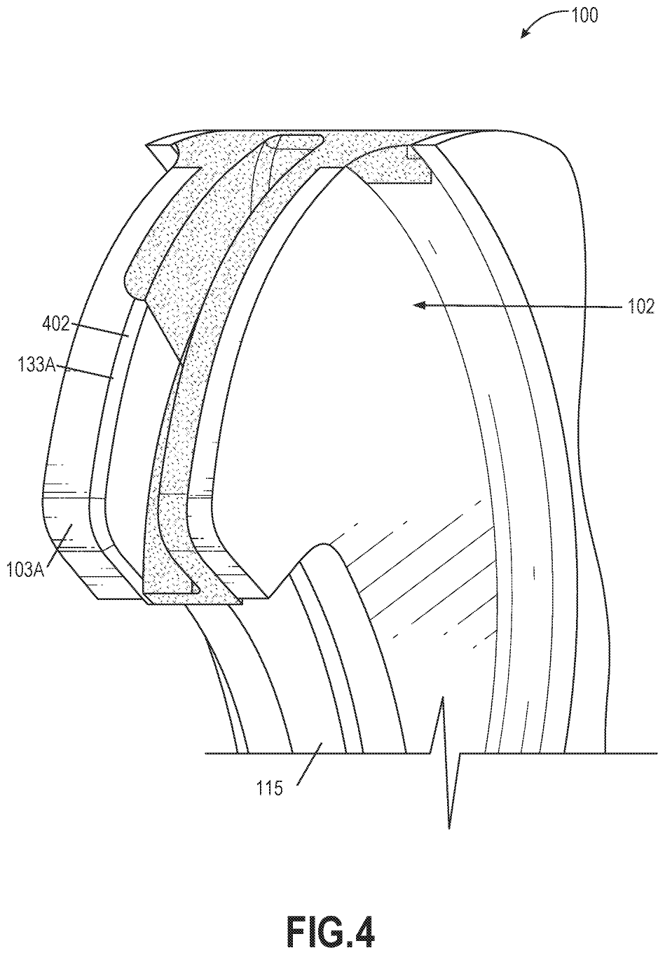

Referring now to FIG. 4, illustrated is an enhanced right perspective view of the petal 100, according to one embodiment of the present disclosure. The outer groove protrusion 103A can include a beveled edge 402. In various embodiments, the beveled edge 402 and the inner edge 133A are substantially similar. The beveled edge 402 can reduce the resistance produced by the body 102 on fluid flowing through the dilating disk valve 800 when transitioning from the opened to closed position or from the closed to opened position. The beveled edge 402 can reduce the force produced on the body 102 by the fluid flowing through the dilating disk valve 800 when transitioning from the opened to closed position or from the closed to opened position. For example, the beveled edge 402 can allow fluid to flow over the body inner edge 133A more easily when the dilating disk valve 800 is opening or closing. In some embodiments, the beveled edge 402 can provide relief to facilitate the fit of the tongue protrusion 115 of an adjacent petal 100 when closing the dilating disk valve 800.

Referring now to FIG. 5, illustrated is an isolated view of the insert 101, according to one embodiment of the present disclosure. In some embodiments, the petal 100 can include pins 501A and 501B. The pin 501A is substantially similar to the pin 501B. The pins 501A-B can be inserted at one end of the body 102. The body 102 includes the apertures 118A-B (not pictured) to facilitate inserting the pins 501A-B, respectively. The insert 101 can include apertures (not pictured) that align with the apertures 118A-B. By aligning the apertures of the insert 101 and the apertures 118A-B, the insert 101 and the body 102 can accept the pins 501A-B. For example, the apertures of the insert 101 can line up with the apertures 118A-B to accept a continuous pin 501A-B. In some embodiments, the pins 501A-B do not fully extend through the body 102. The pins 501A-B can be inserted into the petal 100 using pressure fitting and/or any other appropriate insertion technique. The pins 501A-B can be appended to the petals 100 using gluing, welding, riveting, and/or any other appropriate appending technique.

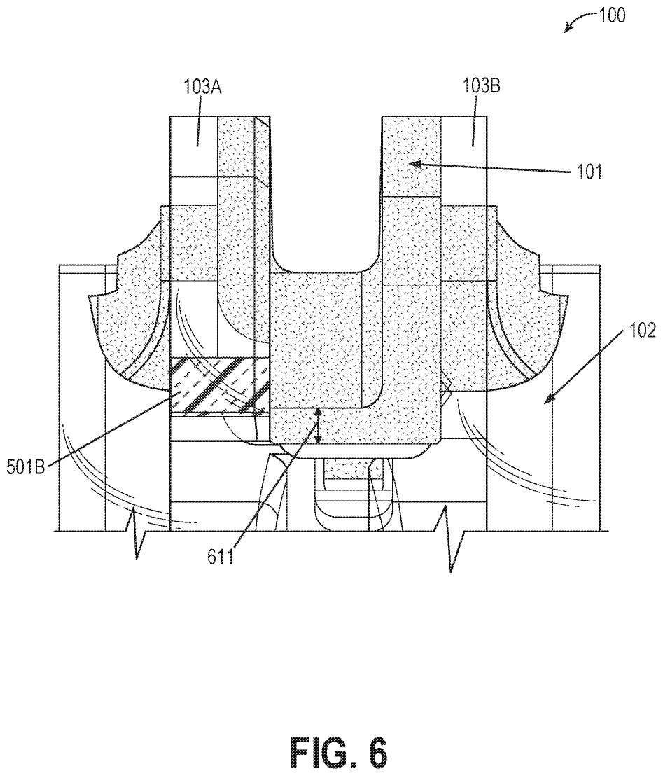

Referring now to FIG. 6, illustrated is a front isolated view of the insert 101, according to one embodiment of the present disclosure. In some embodiments, the pins 501A-B (only pin 501B pictured) can extend through the outer groove protrusion 103A of the body 102. The pins 501A-B can extend through the insert 101. The insert 101 can have a depth 611. The depth 611 can be substantially greater in size than the diameter of the pin 501A-B. Having a depth 611 greater than the diameter of the pins 501A-B can facilitate inserting the pin into the insert 101. The pins 501A-B can extend into a portion of the outer groove protrusion 103B.

Referring now to FIG. 7A, illustrated is the petal 700A, according to one embodiment of the present disclosure. The petal 700 can include an outer groove protrusion 706 and an insert 101B with a longer cutaway inner protrusion 703 that is similar to cutaway inner protrusion 109. The outer groove protrusion 706 can include a shorter inner portion to allow for cutaway inner protrusion 703 to fit. The outer groove protrusion 706 can be otherwise similar to outer groove protrusion 103A.

Referring now to FIG. 7B, illustrated is a petal 700B, according to one embodiment of the present disclosure. In particular embodiments, the petal 700B is substantially similar to the petal 100 with the insert 101C omitting the cutaway inner groove protrusion 109 as compared to insert 101. The petal 700B can omit the cutaway inner groove protrusion 109 and replace the sealing material with the metallic material of the body 102. The petal 700B can include an outer groove protrusion 709. In this example, the insert 101C can include the recessed surface 130 and the rear anchor 108.

Referring now to FIG. 7C, illustrated is a petal 700C, according to one embodiment of the present disclosure. In particular embodiments, the petal 700C is substantially similar to the petal 100 with the insert 101D omitting the full inner groove protrusion 106 and the cutaway inner groove protrusion 109 as compared to insert 101. The petal 700C can omit the cutaway inner groove protrusion 109 and replace the sealing material with a ledge 712 made of the metallic material of the body 102. The petal 700C can omit the full inner groove protrusion 106 and replace the sealing material with a ledge 715 made of the metallic material of the body 102. The petal 700B can include an outer groove protrusion 709. In this example, the insert 101D can include the recessed surface 130 and potentially a rear anchor 108 (not shown). In one embodiment, the sealing material at surface 130 can provide a sufficient seal between the tongue and groove without the full inner groove protrusion 106 and the cutaway inner groove protrusion 109.

Referring now to FIG. 8, illustrated is a perspective view of a dilating disk valve 800, according to one embodiment of the present disclosure. The dilating disk valve 800 includes a petal 100A, 100B, and 100C. In some embodiments, the dilating disk valve 800 is in an open state. When the dilating disk valve 800 is in an open state, a substance can flow through the dilating disk valve 800.

The dilating disk valve 800 can include a controlling arm 801, a controlling pin 802, a hinge pin 803, and an aperture 804. A plurality of controlling arms 801 can connect to the petals 100A-C using the corresponding controlling pin 802. The controlling pin 802 can be an extension of the controlling arm 801 and can insert into the control aperture 121. The controlling pin 802 can exert force onto the petals 100A-C to open or close the dilating disk valve 800. For example, the controlling arm 801 rotates to the right and applies a force onto the petals 100A-C via the controlling pin 802. Continuing this example, as more force is exerted on the petals 100A-C, the petals 100A-C begin to rotate in a clockwise direction. Continuing this example, rotating the petals 100A-C to the right allows the petals 100A-C to close.

The petals 100A-C can rotate around the hinge pin 803. The hinge pin 803 can be inserted into the hinge aperture 124 and can be substantially grounded. In various embodiments, the hinge pin 803 is attached to the valve body of the dilating disk valve 800 to ground the petals 100A-C to a particular location. Grounding the petals 100A-C at the location of the hinge pin 803 can facilitate the petals 100A-C rotating about that location. For example, as a force is exerted by the controlling arm 801 in a clockwise direction, the petals 100A-C are pulled to the right. Continuing this example, the petals 100A-C rotate about the hinge pin 803. Continuing this example, the petals 100A-C continue to rotate until all three petals 100A-C have met at the center of the dilating disk valve 800. On rotating the petals 100A-C with the controlling arm 801, the petals 100A-C can converge to close the dilating disk valve 800. Closing the dilating disk valve 800 can block the aperture 804.

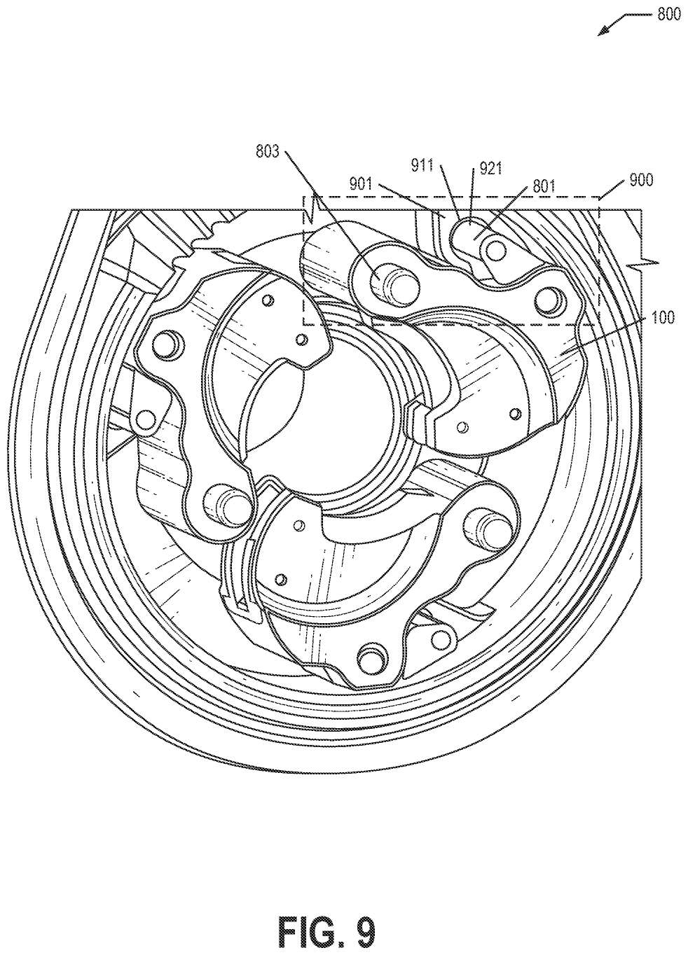

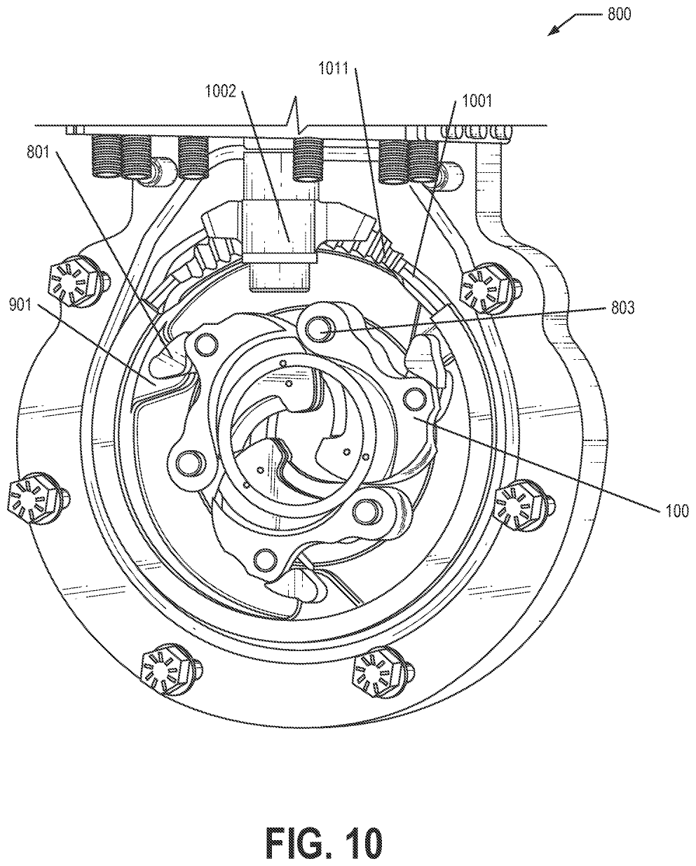

Referring now to FIG. 9, illustrated is a second perspective view of a dilating disk valve 800, according to one embodiment of the present disclosure. The dilating disk valve 800 can include a gear mechanism 900. The gear mechanism 900 can be defined as the system that can provide the necessary forces to open or close the dilating disk valve 800. The gear mechanism 900 can include the controlling arm 801, a controlling base 901, and a rotating arm 1001 (see FIG. 10). The controlling base 901 is fixed to the rotating arm 1001 of the dilating disk valve 800. The controlling arm 801 can include a controlling base pin 921 that can connect to the controlling base 901. The controlling base pin 921 can be inserted into a controlling base aperture 911 of the controlling arm 801. The controlling base pin 921 can be inserted into the controlling base aperture 911 and rotate freely to pivot around the controlling base 901. For example, as the base rotates to a closed position, the controlling base 901 moves with the rotating base in a first direction (e.g., clockwise or counterclockwise). Continuing this example, as the controlling base 901 moves to the first direction, the controlling base 901 applies a force onto the controlling arm 801 and the petal 100 in a similar direction. Continuing this example, as the petal 100 begins to rotate inwards around the hinge pin 803, the control arm rotates inwards relative to the controlling base aperture 911. Continuing this example, the controlling arm 801 will extend perpendicularly from the controlling base 901 once the petal 100 is in a completely closed state.

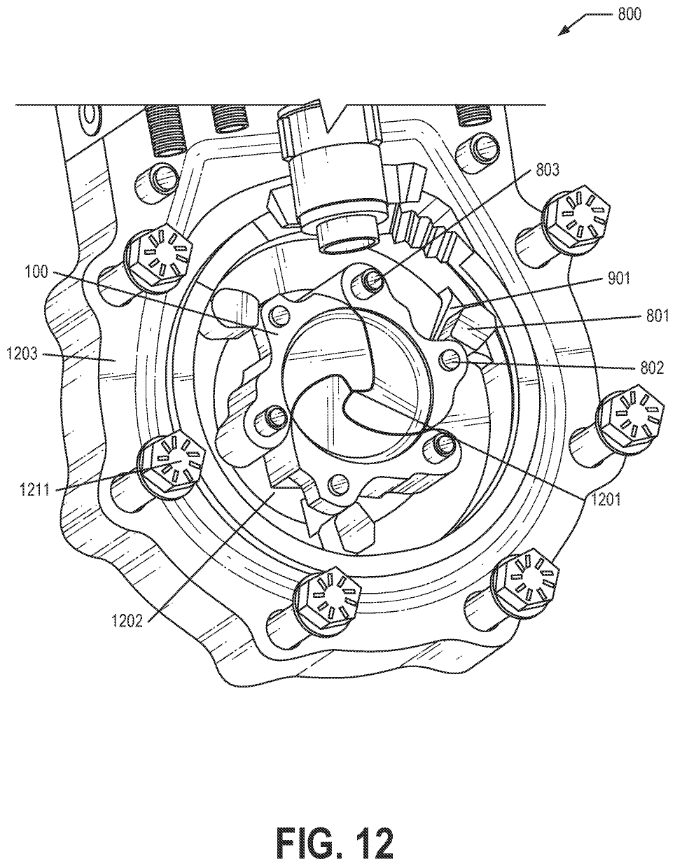

Referring now to FIG. 10, illustrated is a perspective view of a partially closed dilating disk valve 800, according to one embodiment of the present disclosure. The dilating disk valve 800 can include the rotating arm 1001 and a turning device 1002. The rotating arm 1001 can include threads 1011 and can be referred to as a gear mechanism. In some embodiments, the rotating arm 1001 can fit within a ring shaped channel of the valve body 1203 (see FIG. 12). The turning device 1002 can rotate clockwise or counterclockwise to move the rotating arm 1001 in a clockwise or counterclockwise direction. The turning device 1002 can have vertical threads that match the gaps of the threads 1011. In various embodiments, as the turning device 1002 rotates the threads of the turning device 1002 pull or push the threads 1011. In particular embodiments, the pulling or pushing force from the turning device 1002 onto the threads 1011 causes a rotation of the rotating arm 1001. The turning device 1002 can be operated mechanically or automatically. In some embodiments, the turning device 1002 is programmed to turn at particular intervals or for particular conditions. For example, if a leak is detected in the tubing system, the turning device 1002 turns to close the dilating disk valve 800.

A plurality of controlling bases 901 can attach to the rotating arm 1001. For example, in a three petal 100 system, three controlling bases 901 are fixed to the rotating arm 1001. When closing, the turning device 1002 can rotate clockwise and cause the rotating arm 1001 to rotate clockwise simultaneously. As the rotating arm 1001 rotates clockwise, the plurality of controlling bases 901 can rotate in a clockwise direction. As the controlling bases 901 rotate in a second direction, a force can exert onto the petals 100 via the controlling arms 801. As a counterclockwise force is exerted into the petals 100, the controlling arm 801 can rotate clockwise around the controlling base, and the petals 100 can rotate about the hinge pin 803. In various embodiments, the petals 100 can join at the middle of the dilating disk valve 800 to form a seal.

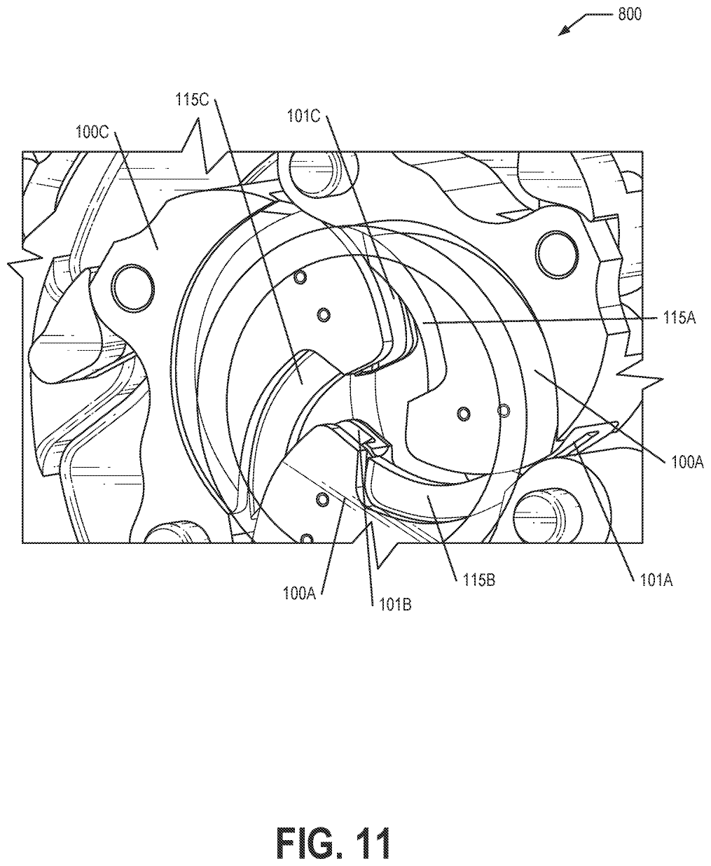

Referring now to FIG. 11, illustrated is an enhanced view of a partially closed dilating disk valve 800, according to one embodiment of the present disclosure. In particular embodiments, the petals 100A-C are in a partially closed position. In this transition state, the tongue protrusions 115A-C can begin to merge with the inserts 101A-C. For example, as the petal 100A is pushed further into a closed state, the tongue protrusion 115A begins to merge with the insert 101C. Continuing this example, the tongue protrusion 115B begins to merge with the insert 101A. Continuing this example, the tongue protrusion 115C begins to merge with the insert 101B. In particular embodiments, the petals 100A-C simultaneously begin to merge as the petals 100A-C are operatively pushed further into the center of the dilating disk valve 800.

Referring now to FIG. 12, illustrated is a perspective view of a closed dilating disk valve 800, according to one embodiment of the present disclosure. In various embodiments, the dilating disk valve 800 includes a closing point 1201, a base 1202, and a valve body 1203. In some embodiments, the valve body 1203 is referred to as a body. The closing point 1201 can mark a location where all three petals 100 are mechanically joined to form a seal. The hinge pins 803 can be fixed to the base 1202. In some embodiments, the base 1202 does not rotate and stays positioned in a particular configuration to facilitate the petals 100 rotation about the hinge pins 803. The valve body 1203 can house all the components of the dilating disk valve 800. In at least one embodiment, the valve body 1203 is joined to the base 1202. The valve body 1203 can incorporate an internal space that contains all the rotating mechanisms of the dilating disk valve 800. The valve body 1203 can include bolts 1211. The valve body 1203 and the bolts 1211 can allow the dilating disk valve 800 to be placed in between two pipes.

In a closed state, the controlling arm 801 can be in a substantially perpendicular state relative to the controlling base 901. When the controlling arm 801 is in a perpendicular state relative to the controlling base 901, the petals 100 can rotate to their maximum closed position. A maximum closed position can be defined as a state where all three petals 100 touch at the closing point 1201 and form an appropriate seal. The appropriate seal of the petals 100 in a closed position can be defined by a maximum amount of fluid flow through the aperture 804 (not pictured) per minute. For example, for the appropriate seal, the petals 100 in a closed state can allow up to 46 milliliters (ml) of fluid flow per minute through the aperture 804. In a maximum closed position, the controlling arm 801 can continue to apply closing pressure onto the petals 100 via the controlling pin 802.

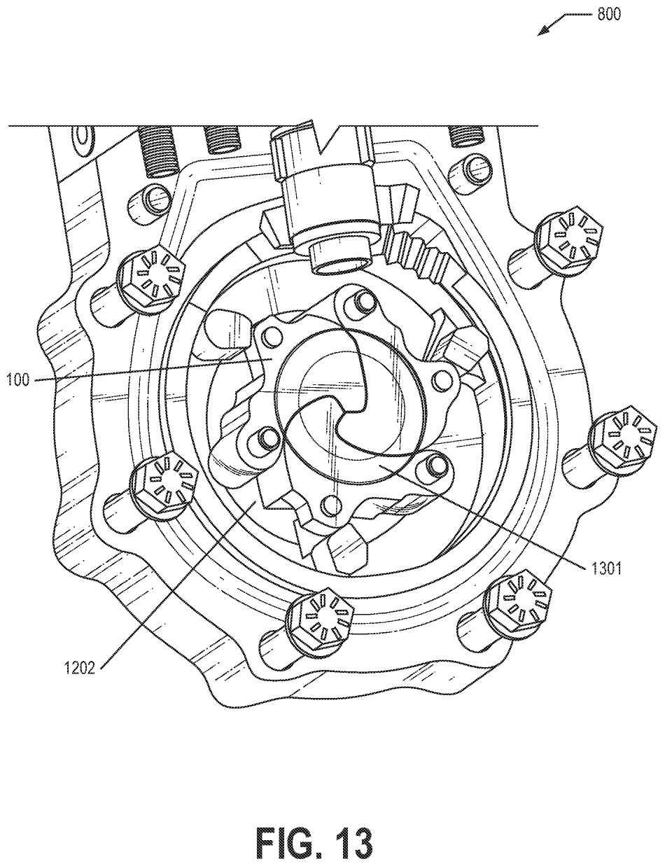

Referring now to FIG. 13, illustrated is a partially transparent view of a closed dilating disk valve 800, according to one embodiment of the present disclosure. In particular embodiments, the dilating disk valve 800 includes a spring disk 1301. The spring disk 1301 can be placed in between the base 1202 and the petals 100. The spring disk 1301 can increase the sealing capabilities of the dilating disk valve 800, particularly during high-temperature use. The spring disk 1301 fits into the curved surface 107 (not pictured) of all three petals 100. The petals 100 can form a flush connection with the spring disk 1301 to increase the sealing capabilities of the dilating disk valve 800.

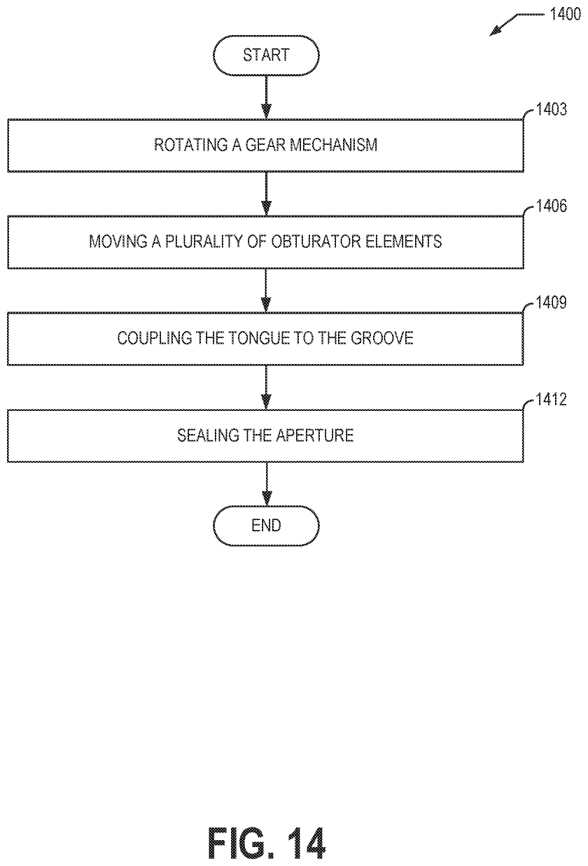

Referring now to FIG. 14, shown is a flowchart of a process 1400, according to one embodiment of the present disclosure. The process 1400 can correspond to the overall functionality of the disclosed system. In particular embodiments, the process 1400 demonstrates a method for closing and sealing a valve for a pathway system.

At box 1403, the process 1400 can include rotating a gear mechanism. The gear mechanism can include the rotating arm 1001 and the turning device 1002. The turning device 1002 can rotate and apply a pulling or pushing force on the threads 1011. For example, if the turning device 1002 rotates in a counterclockwise direction, the turning device 1002 will apply a force on the threads 1011 to the left. The force produce by the turning device 1002 and applied to the threads 1011 can translate the rotation of the turning device 1002 in one direction into the rotation of the rotating arm 1001 in the same direction. For example, if the turning device 1002 rotates in a clockwise direction, the rotating arm 1001 can will rotate in a clockwise direction.

At box 1406, the process 1400 can include moving a plurality of obturator elements, according to one embodiment of the present disclosure. In various embodiments, as the rotating arm 1001 begins to rotate in a particular direction, the plurality of controlling base 901 follows the same path as the rotating arm 1001. For example, if the rotating arm 1001 rotates clockwise, the plurality of controlling bases rotate clockwise. Each controlling base 901 can connect to the plurality of controlling arms 801. The plurality of petals 100 can connect to the controlling arm 801 and to the plurality of hinge pins 803. As the controlling base 901 rotates, the controlling arm 801 pulls the petals 100 in the direction of rotation. As the petals 100 are pulled by the controlling arm 801, the petals 100 begin to rotate about the fixed hinge pins 803. For example, if the rotating arm 1001 rotates in a clockwise direction, the petals 100 begin to rotate about the hinge pins 803 in a clockwise direction. Continuing this example, the petals 100 begin to approach a closing position as they continue to rotate in a clockwise direction.

At box 1409, the process 1400 includes coupling the tongue protrusion 115 to the groove 112, according to one embodiment of the present disclosure. The face 136 can approach the recessed surface 130 of the insert 101 as the dilating disk valve 800 begins to close. In one or more embodiments, the face 136 presses up against the recessed surface 130. As the face 136 and the recessed surface 130 are pressed together, the petals 100 can form a seal to restrict the flow of particular fluids. For example, as one petal 100 approaches an adjacent petal 100, the face 136 of the first petal 100 can couple to the recessed surface 130 of the second adjacent petal 100 as the dilating disk valve 800 closes.

At box 1412, the process 1400 includes sealing the aperture 804, according to one embodiment of the present disclosure. The rotating arm 1001 can lock into place after the petals 100 couple together. Locking the rotating arm 1001 can facilitate a constant seal between the petals 100. In particular embodiments, the dilating disk valve 800 employs any suitable method for constantly applying pressure onto the petals 100 to maintain a sealed position. In a sealed position, the petals 100 can allow up to 46 ml of fluid flow per minute through the aperture 804.

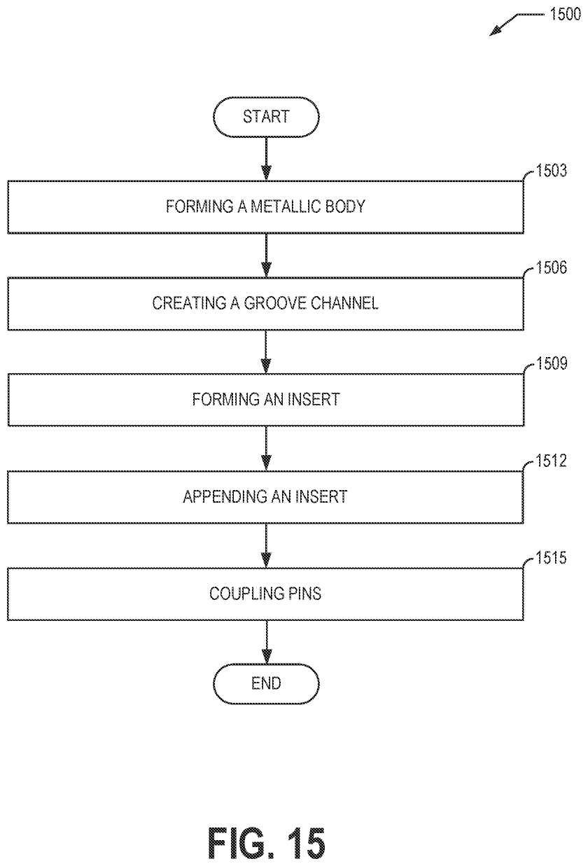

Now referring to FIG. 15, shown is a flowchart of a process 1500, according to one embodiment of the present disclosure. The process 1500 can relate to the method for creating a petal 100. In particular embodiments, the two separate components of the petal 100 are the insert 101 and the body 102. The insert 101 can append to the body 102 to create the petal 100. In an alternative embodiment, the insert 101 and the body 102 are created as one continuous piece using either similar or distinct materials.

At box 1503, the process 1500 includes forming the body 102, according to one embodiment of the present disclosure. The body 102 can be made from any suitable metal material that provides rigidity to the petal 100. The metallic body can be manufactured using, molding, casting, pressing, machine cutting, and/or any other form of suitable forming technique. For example, the body 102 can be formed using machine cutting or computer numerical control (CNC) systems. Continuing this example, the body 102 can be drill pressed to add the plurality of apertures and inserts present throughout the petal 100.

At box 1506, the process 1500 includes creating the groove channel 111, according to one embodiment of the present disclosure. The groove channel 111 can be created by machine cutting the desired area of the body 102. In alternative embodiments, the groove channel 111 is incorporated in the original formation of the body 102. For example, the body 102 can be casted with the groove channel 111 already incorporated into the mold. The groove channel 111 can be cut to specific sizes corresponding to the size of the particular insert 101 being used for the petal 100.

At box 1509, the process 1500 includes forming the insert 101, according to one embodiment of the present disclosure. The insert 101 can be made out of Polytetrafluoroethylene (PTFE) or other sealing material. In some embodiments, the insert 101 can be manufactured using any particular synthetic fluoropolymer, polymer, plastic, metallic, semi-ridged material, or a combination thereof. The insert 101 can be manufactured using compression molding, blow molding, rotational molding, extrusion molding, thermoforming, any other adequate manufacturing technique, or a combination thereof. For example, the insert 101 can be formed by injecting a polyethylene material into a mold.

At box 1512, the process 1500 includes appending the insert 101, according to one embodiment of the present disclosure. In at least one embodiment, the insert 101 can append to the body 102 in the groove channel 111 by any adequate appending technique. Some adequate appending techniques can include, but are not limited to, welding, gluing, riveting, or pressure fitting. The insert 101 can be appended into the groove channel 111 with a combination of appending techniques.

At box 1515, the process 1500 includes coupling pins 501A-B, according to one embodiment of the present disclosure. The insert 101 and the body 102 can be secured together by coupling at least two pins 501A-B to both components. The pins 501A-B can extend through the body 102 and the insert 101. The pins 501A-B can have a total length shorter than the width of the body 102 but greater than the width of the insert 101. In various embodiments, the pins 501A-B are pressure fit into inserts that extend through the body 102 and through the insert 101. The pins 501A-B can be coupled to the petal 100 by using a combination of appending techniques discussed herein.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be affected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

1. An obturator element, comprising:
a petal shape structure;
a first edge portion along a first section of an outside circumference of the petal shaped structure, the first edge portion comprising a first mating surface;
a second edge portion along a second section of the outside circumference of the petal shaped structure, the second edge portion comprising:
an insert comprising a partial surface positioned toward a first side of the petal shaped structure corresponding to a source direction of intended fluid flow and a full surface positioned toward a second side of the petal shaped structure, the second side opposite the first side; and
a second mating surface at least partially formed by the insert;
a control connection portion comprising a first aperture; and
a hinged connection portion comprising a second aperture, wherein the obturator element is configured to pivot about the second aperture of the hinged connection portion based on a movement of the control connection portion.

2. The obturator element of claim 1, wherein the partial surface comprises a partial ledge and the full surface comprises a full ledge.

3. The obturator element of claim 2, wherein the second mating surface comprises the partial ledge of the insert and a second partial ledge of the petal shape structure, wherein the combination of the partial ledge and the second partial ledge form a second full ledge.

4. The obturator element of claim 2, wherein a first edge of a first side wall of the insert intersects a second edge of a central surface, and a third edge of the first side wall abuts the partial ledge.

5. The obturator element of claim 1, wherein the first mating surface comprises a tongue and the second mating surface comprises a groove, and the second mating surface is configured to mate with the first mating surface of an adjacent obturator element by inserting the tongue of the first mating surface of the adjacent obturator element into the groove of the first mating surface.

6. The obturator element of claim 1, wherein the insert comprises a channel, the channel comprising a central surface, a first side wall, and a second side wall, the central surface being substantially perpendicular to the first side wall and the second side wall, wherein first side wall abuts the partial surface and the second side wall abuts the full surface.

7. The obturator element of claim 1, wherein the second section of the obturator element is configured to mate with an adjacent obturator element and the first edge portion of the obturator element is configured to mate with a second adjacent obturator element to prevent fluid flow through a dilating disk valve.

8. The obturator element of claim 1, wherein the insert comprises a non-metallic material.

9. A dilating disk valve, comprising:
a body comprising an aperture;
a plurality of obturator elements configured to restrict fluid flow through the aperture of the body, wherein each of the plurality of obturator elements comprising:
a petal shape structure;
a first edge portion along a first section of an outside circumference of the petal shaped structure, the first edge portion comprising a first mating surface;
a second edge portion along a second section of the outside circumference of the petal shaped structure, the second edge portion comprising:
an insert comprising a partial surface positioned toward a first side of the petal shaped structure corresponding to a source direction of intended fluid flow ad a full surface positioned toward a second side of the petal shaped structure, the second side opposite the first side; and
a second mating surface at least partially formed by the insert, the second mating surface being configured to mate with the first mating surface of an adjacent obturator element;
a control connection portion configured to mechanically couple to body; and
a hinged connection portion configured to couple to the body, wherein the obturator element is configured to pivot about the hinged connection portion based on a force applied to the control connection portion.

10. The dilating disk valve of claim 9, wherein a first material of the insert comprises a lower density than a second material of the petal shape structure.

11. The dilating disk valve of claim 9, wherein the petal shape structure for each of the plurality of obturator elements comprises a second partial surface positioned on a same side as the partial surface of the insert.

12. The dilating disk valve of claim 9, wherein the partial surface of the insert comprises a partial side wall.

13. The dilating disk valve of claim 9, further comprising a gear mechanism configured to fit within a ring shaped channel of the body, wherein the control connection portion is further configured to couple to the gear mechanism and each of the plurality of obturator elements is further configured to pivot about the hinged connection portion based on a movement of gear mechanism within the ring shaped channel.

14. The dilating disk valve of claim 9, wherein the plurality of obturator elements comprise a first obturator element, a second obturator element, and a third obturator element, wherein the first mating surface of the first obturator element is configured to mate with the second mating surface of the second obturator element, the first mating surface of the second obturator element is configured to mate with the second mating surface of the third obturator element, and the first mating surface of the third obturator element is configured to mate with the second mating surface of the first obturator element.

15. The dilating disk valve of claim 9, wherein the first edge portion comprises a first contoured shape and the second edge portion comprises a second contoured shape inverse to the first contoured shape.

16. A method, comprising:
rotating a gear mechanism about a ring shaped channel in a body, wherein the body comprises an aperture;
moving, via the gear mechanism, a plurality of obturator elements about a respective hinged connection portion by moving a respective control connection portion coupled to the gear mechanism, wherein each of the plurality of obturator elements comprises the respective hinged connection portion and the respective control connection portion;
coupling a respective first edge portion positioned along a first section of an outside circumference of each of the plurality of obturator elements with a respective second edge portion along a second section of the outside circumference of an adjacent one of the plurality of obturator elements, wherein the respective second edge portion comprises an insert with a partial surface positioned toward a first side and a full surface positioned toward a second side, the second side being opposite the first side; and
sealing, based at least in part on the coupling the respective first edge portion for each of the plurality of obturator elements with the respective second edge portion of the adjacent one of the plurality of obturator elements, the aperture of the body to prevent fluid from flowing through the aperture.

17. The method of claim 16, wherein the respective first edge portion comprises a tongue shaped portion and the respective second edge portion comprises a groove shaped portion for each of the plurality of obturator elements.

18. The method of claim 16, further comprising affixing the insert into a groove channel of the respective second edge portion of each of the plurality of obturator elements.

19. The method of claim 16, further comprising aligning a first partial ledge of the insert with a second partial ledge of the respective second edge portion for each of the plurality of obturator elements.

20. The method of claim 16, further comprising injecting a non-metallic material into a mold to form the insert.
